(19) United States
(12) Patent Application Publication
(10) Pub. No.: US 2010/0084124 A1
(43) Pub. Date: Apr. 8, 2010

(54) Ripening/Storage Room for Fruit and Vegetables with Reversible Air Flow and "Stop & Go" Modulation of Air Flow

(75) Inventor: Stanislaw Franaszek, Tulln Niederosterreich (AT)

Correspondence Address: FROST BROWN TODD, LLC, 2200 PNC CENTER, 201 E. FIFTH STREET, CINCINNATI, OH, 45202, US

(73) Assignee: Chiquita Brands, Inc., Cincinnati, OH (US)

(21) Appl. No.: 12/565,196

(22) Filed: Sep. 23, 2009

Related U.S. Application Data
(60) Provisional application No. 61/103,776, filed on Oct. 8, 2008.

(51) Int. Cl. F24F 11/053; A23B 7/144; G05D 23/00

(52) U.S. Cl. 165/247; 99/468; 700/300

(57) ABSTRACT

The invention relates to a control system of a ripening (store) room for fruit and/or vegetables, and more particularly for bananas, and a device(s) for carrying out that method. The invention relates to the construction of said room to provide the most symmetrical distribution of heat across the load stacked in room space during ripening/store periods, due to periodically switching ON and OFF of heating, cooling and process air fans, as well as due to a suitable process control method. The new process control system is designed for the most efficient operation and energy consumption of said system during ripening (storage) time.

According to the invention, the air (which also includes fluid circulating inside the ripening/store room (for example during Controlled Atmosphere (CA) storage) is cooled (or heated) and guided across the fruit (vegetables) by circulation through the load placed in boxes and loaded on the pallets in the manner most suitable for the actual biological and biochemical activity of said load. The air fans blow the process air through the load as well as cooling and heating elements, not always at full performance (nominal capacity) level. In order to achieve the optimal level, work needs to be modulated so as to keep all three elements, air flow, cooling and heating in a stable balance with a load stacked in the room so as to compensate for differences in loading (full load vs. part load) and in bio-activity of load during the ripening (store) process.

This application relates to and claims priority from U.S. Provisional Patent Application Ser. No. 61/103,776, filed Oct. 8, 2008, incorporated herein by reference.

### BACKGROUND OF THE INVENTION

1. Technical Field

The invention relates generally to a ripening/store room which maintains product by circulating air internally through the room, and more particularly, to a ripening/store room which enables air to flow (to be modulated) in the most efficient way in a reversible path where the relative volume of air, as well as intensity of cooling (heating), is modulated to a level needed for efficient and optimal management of the ripening (storage) process, wherein energy consumed during ripening (storage) is kept at the most optimal level and at the same time the air flow path is substantially symmetric across the load.

2. Discussion

Modulation of the Air Volume

The air fans and cooling/heating elements installed in commercial ripening (store) rooms are designed for maximum performance, meaning that they are designed to work with a fully loaded room and the maximum cooling (heating) performance calculated for a short ripening cycle and/or emergency cooling (heating). Such concept requires use of over-dimensioning components of the said technical installations which work with their nominal (installed) capacity for a short time only. It is clear that installed technical components and/or systems generally are not efficient for a fractional load (capacity output of about 50% or less) or where the load is already cooled down and its respiration is at the minimum level. Under such circumstances, the only possibility to optimize efficiency is to decrease capacity output of the installed components to the necessary level and in that way guarantee stable work of all components as well as the whole system.

With the understanding that the air fans are the biggest energy consumers in such ripening/store rooms, the right modulation of air fans (air flow) is one of the most crucial points for optimizing the whole system. One of the ways to achieve such optimization is a modulation of the process air with the help of speed controllers. Based on the fact that boxes (pallets) used for transport of fruits or vegetables are not built from a homogenous material with uniform air permeability across the whole load stacked in the ripening/store rooms, such analogue modulation leads to significant change of the air stream across the room and load, which leads to higher temperature differences across goods loaded in the room. Here, the right solution seems to be so-called “pulse wide modulation” (PWM), meaning that the air fans are switched periodically ON and OFF, depending on actual demand. Of course, the ON and OFF periods are flexible and dependent on the load stacked in the room, as well as the cooling/heating demand in the process. Simple and direct use of such modulation will lead to increase of the temperature gradient across the load; here, the temperature and color difference of bananas between inlet and outlet sides will be bigger. Only appropriate interactive modulation of the “GO” and “STOP” periods can guarantee optimal energy consumption with minimal temperature gradient across the load, helping to assure high quality storage or ripening condition.

### Principles of Process Control

Existing process control systems used for temperature control in ripening/store rooms can be divided in two general groups:

A. Digital and/or analogue thermostats (controllers) work with sensor(s) measured temperature of product. Here, one or more sensors are installed inside a load among, for example, banana fingers. The modulation of the cooling/heating based on the difference between set point adjusted at the process thermostat (process controller) and the actual product temperature measured by the sensor installed in or among the goods cannot be stable because the heat capacity of the load is much too big in comparison with the heat capacity of the air. Here, for example, heat capacity of 24 banana pallets (˜22,000 kg bananas) stacked inside the ripening/store room provides a heat load of about 75,000 kJ/K deg, and about 300 kJ/K deg represents ˜170 m³ air inside the same room. It is clear that such configuration cannot provide stable air temperature. In most cases, the control systems tends to “fix” the air temperature in the room to a possible minimum for cooling or to a possible maximum for heating, both limited by capacity of installed aggregates or limited by additional extra min/max thermostats to keep the air temperature within the acceptable “range”. Due to such variation of air temperature, loaded fruit/vegetables lose moisture leading to decreased quality or to damage of stored (ripened) goods. This system guarantees quick control to a predetermined temperature, but is based on big variations of air temperature in the ripening (store) room and therefore cannot be used for sensitive goods which should not be “overheated” or even “undercooled”. Such conventional systems cause quite a large temperature gradient across the load (inlet vs. outlet).

B. Digital and/or analogue thermostats or controllers work with one or more sensors measuring the air temperature in the controlled room. Such a system keeps the room temperature quite accurately adjusted to the set point, but does not “see” the load and works the same way with a full vs. fractional load, as well as with fruit having a low respiration rate vs. fruit in the peak of respiration. In such situations there is a significant difference between an adjusted set point and the real temperature of the load in the room. The ripening (store) rooms with air temperature control do not compensate for the thermal activity of goods loaded into the room (respiration heat, etc.); in the case of bananas, the real temperature difference could be ˜2.5 K deg or more. Also, based on the fact that the air has very low heat capacity (˜1.3 kJ/Nm³×K deg) as compared with the heat capacity of the goods in the room (bananas ˜3.6 kJ/kg×K deg) and due to a direct (small) change of temperature set point, the cooling down (heating up) periods are longer in order to cool down (or heat up) goods to a predetermined temperature.

The above suggests that the best solution is a mix of both of the above methods, providing a so-called “cascade control system”. In such solution, the temperature difference between the actual product temperature and the adjusted set point for the product determines the air temperature in the ripening/store room. The disadvantage of such a control method is a moderate variation of the air temperature in the room which causes some dehydration of loads in the ripening/store room and can cause stress to sensitive fruit. From one side, such “control cascade” needs to be fast in reaction to follow demands of the ripening/store program, but from the other side it needs to be stable to “conserve” stable air temperature and high humidity in the room. One solution is to build into the chain of control system a logical block that will calculate the right “offset” for the “air” set point but which is not permanently integrated into the control loop; such “offset” will be periodically activated (here integrated into control algorithms) to correct the set point for the air to the right level. Such intervals could be pre-determined as fixed parameters or could be flexible and dependent on cooling/heating demand.

It is, therefore, an object of the present invention to improve construction of ripening (store) rooms (room construction itself, as well as a control system and control method) that are used for ripening (storage) of perishable goods (fruit and vegetables) in a way to decrease the energy consumption due to use of appropriate modulation of air fans installed therein.

It is also an object of the present invention to improve construction of ripening (store) rooms (room construction itself, as well as a control system and control method) that are used for ripening (storage) of perishable goods (fruit and vegetables) in a way to decrease the temperature gradient across the load in the room.

It is also an object of the present invention to improve construction of ripening (store) rooms (room construction itself, as well as a control system and control method) that are used for ripening (storage) of perishable goods (fruit and vegetables) in a way to decrease potential dehydration of said load by minimizing the possible temperature difference between load and air in the room.

It is also an object of the present invention to improve construction of ripening (store) rooms (room construction itself, as well as a control system and control method) that are used for ripening (storage) of perishable goods (fruit and vegetables) in a way to decrease potential dehydration of said load by minimizing increase (maximize) in stability of the air temperature in the room.

It is also an object of the present invention to improve construction of ripening (store) rooms (room construction itself, as well as a control system and control method) that are used for ripening (storage) of perishable goods (fruit and vegetables) in a way to maximize reaction of the system to variable process demands in the room.

### SUMMARY OF THE INVENTION

This invention is directed to a room for ripening and/or storage of a fruit/vegetable load in which the room has interactive modulation of air flow, cooling and heating. The room includes a cooling/heat source and a control system for achieving a predetermined temperature within the room.

Fans circulate air within the ripening (store) room. A number of vent holes (windows) and/or air ducts direct the circulating air through the room, and the circulating air follows a continuous path which includes the loading space of the room, the AMU (Air Modifying Unit), vent holes and the air ducts. A pair of flow reversal vent holes (flaps) are positioned in the continuous path and enable reversal of the direction of the continuous path of the air flow. When the flaps (windows) are in a first configuration, air circulates in a first direction, and if the windows are in a second configuration, the air circulates in the opposite direction.

These and other advantages and features of the present invention will become readily apparent from the following detailed description, claims and drawings.

### BRIEF DESCRIPTION OF THE DRAWINGS

The drawings, which form an integral part of the specification, are to be read in conjunction therewith, and like reference indicators are employed to designate identical components in the various views:

FIG. 1 is a concept drawing of “Stop & Go” modulation in a conventional room with one direction flow of the processed air.

FIG. 2 is a concept drawing of “Stop & Go” modulation in a room with reverse direction flow of the processed air.

FIG. 3 is a concept drawing of “Stop & Go” modulation based on temperature hysteresis.

FIG. 4 is an analogue concept of “Stop & Go” modulation.

FIG. 5 is a block drawing of a conventional temperature control cascade.

FIG. 6 is a block drawing of an advanced control cascade with integrated timer for more stable working of the whole system.

### DETAILED DESCRIPTION OF THE INVENTION

### Principle of “on/Off” Modulation in a Ripening Room with One Direction Flow of the Process Air

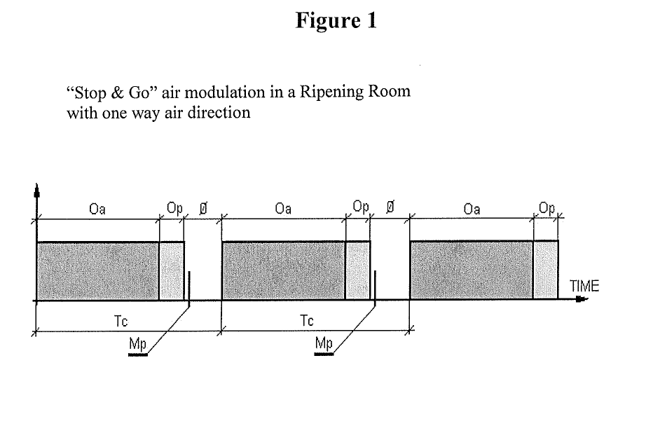

FIG. 1 shows a concept diagram of a so-called “Stop & Go” air modulation in a ripening room with conventional one-way direction flow of the process air.

In this figure, the reference indicators have the following meanings:

Tc=Cycle Time

Oa=Active Operation Time With Cooling/Heating

Op=Passive Operation Time (Air Fans Only)

Mp=Measure Of Product Temperature

Ø=Passive Time; Cooling/Heating And Air Fans “Off” “Stop Time”

Due to a production process and/or behavior of goods loaded in the room, a maximum capacity of air flow is needed only for a few hours during excessive cooling down, heating or compensating of respiration heat during a time of a peak of climacterium. The intensity of the air flow can be reduced to a lower level to save energy consumed by the system as well as to maintain the high quality of the final product (i.e., minimize dehydration). The FIG. 1 diagram shows working cycles of the system; each cycle consists of periods:
Period “Oa”—time where air flow and cooling (heating) is active (is “ON”)
Period “Op”—time where only air fans (air flow) is “ON”
Period “Ø”—time where whole system is “OFF”

The lengths of the “Oa”, “Op” and “Ø” periods are flexible and dependent on:
actual temperature difference between the load (for example, bananas) and an adjusted set point;
actual volume of the load (cargo) stacked in the room (full load vs. part load); and
intensity of heat produced by the load (respiration heat, etc.).

In a situation with intensive cooling based on a larger temperature difference between bananas and the adjusted set point, or in a situation with high respiration heat of the load, the active “Oa” periods with active operated air fans and cooling/heating, are longer, and the passive “Ø” OFF periods are shorter. In a situation with extensive cooling because of fractional load in the room or a low respiration heat of the load, the “Oa” active periods will be shorter. Where the room is loaded with a “green” fruit with low respiration intensity, the “Oa” periods will be shorter and passive “Ø” periods will be longer.

In a room with a fractional load, the “Stop” periods “Ø” will be longer in comparison to a room which is fully-loaded.

The “Op” period is a flexible and determinate time to equalize the temperature between the air inlet and air outlet; a measurement of a pulp temperature of bananas will be done in the last seconds of the “Op” period.

Principle of “ON/OFF” Modulation in a Ripening Room with Reversible Direction Flow of the Process Air

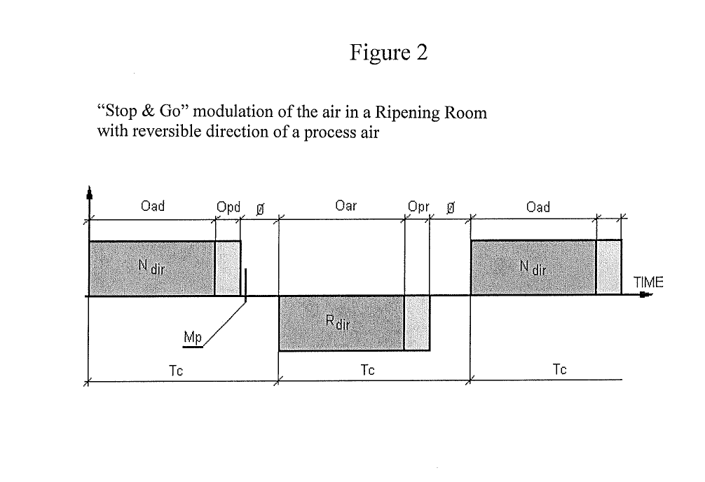

FIG. 2 shows a concept diagram of the “Stop & Go” air modulation in the rooms with reverse direction flow of the process air. As described above, based on the volume loaded into the room as well as due to the specific heat production of the load (respiration), a maximum capacity of air fans is needed for only a few hours during the storage (ripening) process. The intensity of the air flow can be reduced to a necessary level to save energy as well as to maintain the high quality of the final product (i.e., minimize dehydration).

In this figure, the reference indicators have the following meanings:

Tc=Cycle Time

Oad=Active Operation In Normal Direction

Opd=Passive Operation In Normal Direction

Mp=Measurement Point Of Product Temperature

Ø=Passive Time-Cooling/Heating and Air Fans “Off”

Oap=Active Operation In Reverse Direction

Opr=Passive Operation In Reverse Direction

The diagram shows the air flow in a normal direction (above the “x” line) and in a reverse direction (below the “x” line). Each cycle in the normal or reverse direction consists of three periods:
Period “Oad” (Oar)—time where air flow and cooling (or heating) is active (is “ON”)
Period “Opd” (Opr)—time where only air flow is “ON”
Period “Ø”—time where the whole system is “OFF”

As described above, the length of the “Oad” (Oar), “Opd” (Opr), and “Ø” periods is flexible and dependent on:
actual temperature difference between the load (for example, bananas) and an adjusted set point;
actual volume of the load (cargo) stacked in the room (full load vs. part load); and
intensity of heat produced by the load (respiration heat, etc.).

In a room with fruit in intensive cooled down operation (bigger temperature difference between, for example, bananas and the adjusted set point), the “stop” periods will be shorter than in a room where the load has already achieved the adjusted set point temperature.

In a room loaded with green fruit with low respiration intensity, the “OFF” periods will be longer than in a room where fruit will be at the peak of respiration.

In a room which is only part loaded, the “Stop” periods will be longer in comparison to a room which is fully-loaded.

The “Opd” (Opr) periods have flexible length and during that time the system should equalize the temperature between air inlet and air outlet. The measurement of the pulp temperature of the bananas is done in the last seconds of the “Opd” (Opr) periods.

A Direct (Discrete) Type of Stop & Go Modulation with “ON/OFF” Hysteresis

There are two ways of realization of “Stop & Go” modulation in this model:

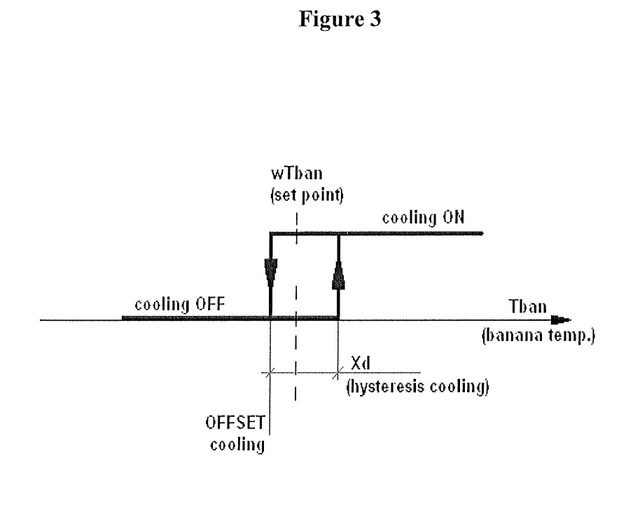

1. the first one shown in FIG. 3, is based on a simple “ON/OFF” hysteresis implemented in a control loop in a way where the “Stop & Go” modulation starts after the banana temperature will be “inside” a set temperature hysteresis (inside an adjusted range); and

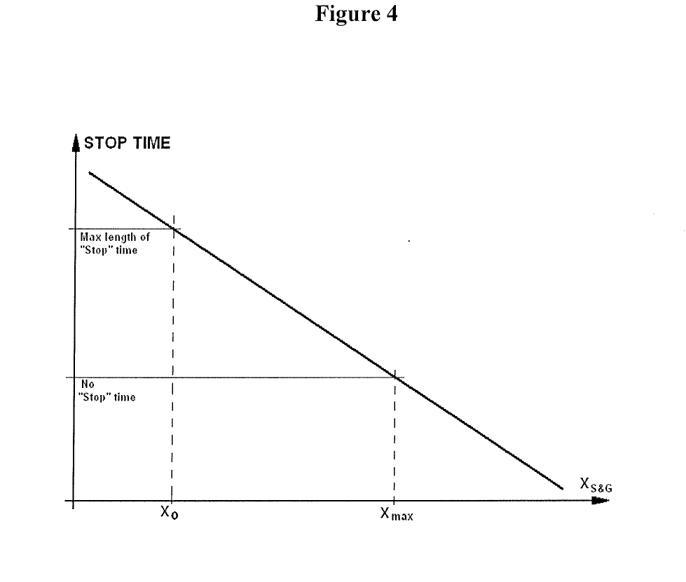

2. the second shown in FIG. 4, is more sophisticated and allows higher savings of energy. In this model, the length of “Stop” and “Go” time is calculated periodically every time the system is switched from normal to reverse operation mode (could also be opposite) and is kept for the whole cycle, the length of the “Go” and “Stop” periods based on process data like that listed below:

relative opening of a cooling modulation valve in percent reflecting the actual heat load the system is working with (fruit respiration intensity) [%];

relative temperature difference between set point adjusted and actual banana temperature to adjusted range [%]; and

relative part loading [%].

The length of the “Stop” time is represented by the “X_{S&G}” value described as follows:

X_{S&G}=f{heat load×temp. diff×part load} [%]

A new setting for the “Go” time (Oad, Oar, Opd and Opr) and for the “Stop” time (Ø) are valid for a one full reverse cycle (one “reverse” and one “normal” air flow period) and is calculated, based on the above formula, at the end of the time with passive cooling (heating) and active air fans (period when only the air fans work). If the calculated “X_{S&G}” index is lower than a critical value “Xₖᵣᵢₜ” adjusted as a process parameter, the “Stop & Go” modulation is activated as follows:

if X_{S&G}>Xₖᵣᵢₜ, then no “Stop & Go” modulation

if X_{S&G}<Xₖᵣᵢₜ<Xₒ, then Stop & Go modulation active

if X_{S&G}<Xₒ then Stop time fixed (maximum length of the “Stop” time)

The relative length of the Stop time is dependent on the value of the “X_{S&G}” index: a lower value results in longer “Stop” time (shorter “Go” time). The maximum length of the “Stop” time is limited by other parameters to guarantee stable and effective working of the process control (X_{S&G}<Xₒ). The main difference of this kind of modulation to that described above based on temperature “hysterises”, is the fact that the modulation starts before actual banana temperature achieves the set point. This allows better energy efficiency, but is more complicated in adjustment of work parameters.

Principle of the Air Temperature Control with Use of Control Cascade

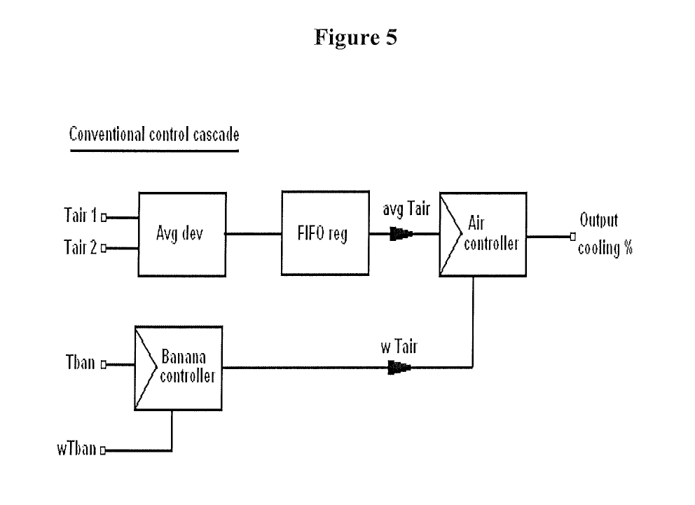

The most advanced control system used in banana ripening rooms is based on the principle of so-called “control cascade” built from two controllers in a row (cascade) like that shown in FIG. 5. This configuration allows proper control of the process and “achievement” of an adjusted banana temperature (Tban) in a stable manner. The only disadvantage of such cascade controller is the fact of unstable air temperature (Tair) inside the room; here each change of banana temperature of about 0.1 K deg (resolution of the controller) can cause change of the air temperature inside the room by about 0.5-1.0 K deg and more.

Principle of the Air Temperature Control with Use of Control Cascade Including Periodic Compensation for Banana Temperature

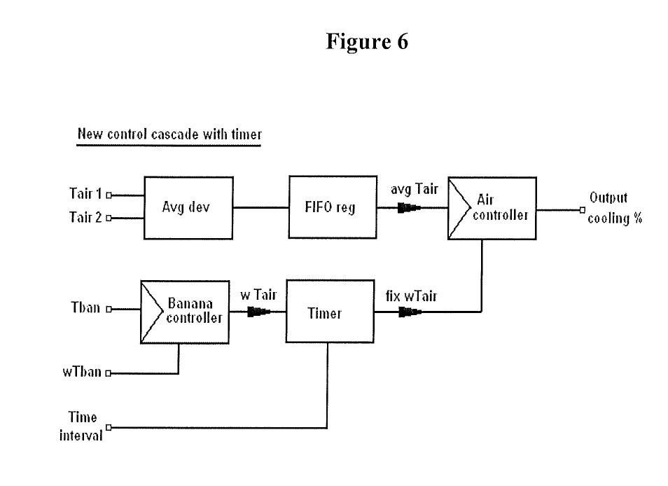

To increase stability of the air in the ripening room, a new control cascade has been developed (see FIG. 6). In this new configuration, a timer block is set between the product (banana) controller and the air controller. It is meant that the set point for the air temperature is fixed for a period of time adjusted on the timer (parameter) and refreshed after the timer gives a release (for example, every 10 minutes). In the meantime, the set point for the air is fixed the whole time between measurements. This configuration guarantees a stable air temperature in the room and also guarantees quick reaction if the set point value or banana temperature are changed.

What is claimed is:

1. A fruit ripening room control system which operates the fans controlling the air flow, the direction of the air flow, and the heating/cooling system in a fruit ripening room, wherein air flow in the room can be in the direct and reverse directions, and the air flow may be split into three periods: a first period wherein the main air fans are “ON” and cooling/heating is enabled; a second period wherein the fans are “ON” but cooling/heating is disabled; and a third period wherein the fans and cooling/heating are “OFF”, said system controlling these variables such that the temperature of the air in the ripening room or the fruit in the ripening room meets a set temperature target.

2. The control system according to claim 1 wherein the length of the air flow periods in the direct, as well as in the reverse, direction is dependent on thermal activity of the fruit load in the ripening room, of the cooling/heating demand, and of the symmetry of the air flow circulation system in the room.

3. The control system of claim 1 wherein the fruit load is bananas.

4. A temperature control system for a fruit load in a fruit ripening room, which starts operation using product modulation to integrate product temperature into a control cascade to cool down or heat up the fruit load to a pre-set temperature as quickly as possible; and thereafter, after a pre-adjusted time, the system switches automatically over to air modulation to build a stable, environment-friendly condition inside the room for ripening of the load.

5. The temperature control system of claim 4 wherein the control system works according to the air modulation method and automatically readjusts the set point based on the difference between the actual fruit temperature and the current set point for the fruit temperature.

6. The temperature control system of claim 4 which works according to the air modulation method, and has one or more active product sensors placed between stored goods and calculates the best supply air temperature according to the cascade control principle (soft “PID” controller) to balance out the deviation between actual value measured and set point adjusted.

7. The temperature control system of claim 4 wherein the fruit load is bananas.

8. A temperature control system for a fruit ripening room wherein the control system includes one or more air temperature sensors, and wherein the final measured temperature value is an average measured from the sensors as well as an average built from measurement in the previous seconds as a FIFO (first in first out) register to register a stable reading.

9. The temperature control system according to claim 8 wherein two or more of said sensors watch each other and a temperature difference measured between said sensors greater than an adjusted value generates a warning, after a time delay.

10. The temperature control system according to claim 9 which switches itself OFF, automatically, when the measured value is out of the adjusted range.

11. The temperature control system according to claim 8 which incorporates both air and product temperature sensors wherein the control system automatically switches over to a pure air modulation system in case when the measured value monitored by the product sensor is out of a pre-adjusted range.

12. The temperature control system according to claim 8 wherein the fruit load is bananas.
